(19) United States
(12) Patent Application Publication
(10) Pub. No.: US 2011/0225459 A1
(43) Pub. Date: Sep. 15, 2011

(54) GENERATING A DEBUGGABLE DUMP FILE FOR A VIRTUAL MACHINE

(75) Inventors: THOMAS FAHRIG, REDMOND, WA (US); YUE ZUO, REDMOND, WA (US); FRANCIS MANOJ DAVID, BELLEVUE, WA (US); YIMIN DENG, SAMMAMISH, WA (US); HO-YUEN CHAU, REDMOND, WA (US); FORREST CURTIS FOLTZ, REDMOND, WA (US)

(73) Assignee: MICROSOFT CORPORATION, Redmond, WA (US)

(21) Appl. No.: 12/720,474

(22) Filed: Mar. 9, 2010

(51) Int. Cl. G06F 11/36; G06F 9/455

(52) U.S. Cl. 714/37; 718/1; 714/E11.208

(57) ABSTRACT

Cloud computing platforms having computer-readable media that perform methods to generate debuggable dump files are provided. The cloud computing platform includes at least one server having a host virtual machine, guest virtual machine, and hypervisor. The host virtual machine receives a command to generate the debuggable dump file. In response, it suspends all virtual processors executing on the guest virtual machine. The memory pages of the suspended virtual machine are written into a debuggable dump file, and the suspended processors are resumed at an appropriate time.

### BACKGROUND

Conventionally, cloud computing platforms host software applications in an Internet-accessible virtual environment. The cloud computing platform allows an organization to use datacenters designed and maintained by third parties. The conventional virtual environment supplies small or large organizations with requested hardware resources, software resources, network resources, and storage resources. The virtual environment also provides application security, application reliability, application scalability, and application availability.

The software resources in a cloud computing platform may include a hypervisor that partitions physical machines into virtual machines. The operating system software running on these virtual machines provides the environment to execute software applications.

The software resources in the conventional datacenters may exhibit unexpected behaviors that require debugging. Software developers use a debugger to diagnose such behaviors. For instance, unexpected values or unauthorized access requests generated by the resource may be identified by the debugger. Accordingly, the debugger helps cure unexpected resource behaviors and reduce the number of defects in the resource. A debugger may be directly attached to the resource to allow online debugging.

When a debugger is directly attached to the operating system software running in a virtual machine, the virtual machine cannot operate normally. The debugger affects availability of the applications running in the virtual machine. This approach is therefore not viable for cloud computing platforms.

### SUMMARY

To allow debugging without impacting application availability in cloud computing platform, it is necessary to capture the state of the virtual machine and generate a debuggable dump file. Embodiments of the invention relate, in one regard, to cloud computing platforms, computer-readable media, and computer-implemented methods that generate consistent debuggable dump files that are used by a debugger to debug resources in a cloud computing platform. The cloud computing platform has a number of computing devices that are available in a datacenter. The computing devices include servers that are configured with virtualization resources. Each server may have a hypervisor that partitions the physical machine into a host virtual machine and guest virtual machines.

A debuggable dump file for a guest virtual machine is generated by first suspending execution of its virtual processors. The host virtual machine stores memory pages associated with the suspended guest virtual machine in the debuggable dump file. The host virtual machine obtains guest virtual machine processor context information from the hypervisor and stores it in the debuggable dump file. The suspended guest virtual machine is resumed after the requested memory pages have been saved.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 is a network diagram that illustrates an exemplary cloud computing platform in accordance with embodiments of the invention;

FIG. 2 is a block diagram that illustrates an exemplary computing device configured to generate a debuggable dump file in the exemplary cloud computing platform; and

FIG. 3 is a logic diagram that illustrates an exemplary method to generate a debuggable dump file for a virtual machine in the cloud computing platform.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, and firmware. Moreover, the term “hypervisor,” as utilized herein, refers to a virtualization component of the cloud computing platform.

Embodiments of the invention generate a debuggable dump file that can be loaded in a debugger. The debugger diagnoses issues with the resources whose states is captured in the debuggable dump file.

An administrator of the cloud computing platform issues a command to generate a debuggable dump file for a guest virtual machine executing on a server. The command may request any subset of memory pages to be included in the debuggable dump file. The host operating system kernel suspends all processors executing in the guest virtual machine. The memory pages for the suspended virtual machine are written to a debuggable dump file. The host operating system obtains virtual processor context information for the guest virtual machine from the hypervisor. The memory pages and processor contexts are merged and saved in the debuggable dump file, which a debugger may load to diagnose defects in the guest virtual machine. The host virtual machine resumes execution of the guest virtual machine.

When the debuggable dump file is loaded into a debugger, it enables debugging of the software that was running inside the guest virtual machine at the time the debuggable dump file was generated. For instance, a developer may use the debuggable dump file to debug an operating system or applications running inside the guest virtual machine.

This is accomplished without directly attaching a debugger to the guest virtual machine, crashing the guest virtual machine to obtain a memory dump, or logging into the guest virtual machine to obtain a memory snapshot. Thus, the host operating system minimizes any adverse impact on the normal operation of the guest virtual machine or services provided by the guest virtual machine.

The cloud computing platform is configured to generate the debuggable dump file in response to a command to generate a debuggable dump file for a guest virtual machine executing on a server. The command may be issued by an administrator of the cloud computing platform to the host virtual machine. The host operating system suspends all processes executing on the guest virtual machine. In turn, memory pages for the suspended processes are written to a debuggable dump file. The hypervisor also stores processor context information and debug information in the debuggable dump file. Accordingly, the debuggable dump file allows a debugger to debug software running inside the guest virtual machine. For instance, a developer may use the debuggable dump file to debug an operating system or applications running inside a guest virtual machine without attaching a debugger, crashing the guest virtual machine to obtain a memory dump, or logging into the guest virtual machine to obtain a memory snapshot. Thus, the server attempts to minimize any adverse impact on the normal operation of the guest virtual machine or services provided by the guest virtual machine.

The debuggable dump file is generated without crashing the cloud computing platform. The host virtual machines pause the guest virtual machine, capture memory pages, and obtain additional information, like processor contexts, from the hypervisor. The guest virtual machine is resumed at an appropriate time. The memory pages and processor contexts are merged and saved in a debuggable dump file, which a debugger may load to diagnose the guest virtual machine.

As one skilled in the art will appreciate, the cloud computing platform may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In an embodiment, the cloud computing platform includes cloud applications that are available to client devices. The client devices access the cloud computing platform to execute the cloud applications. The cloud applications are implemented using storage and processing resources available in the cloud computing platform. The cloud computing platform may be a datacenter with several computing devices that may be virtualized to support access by the client devices.

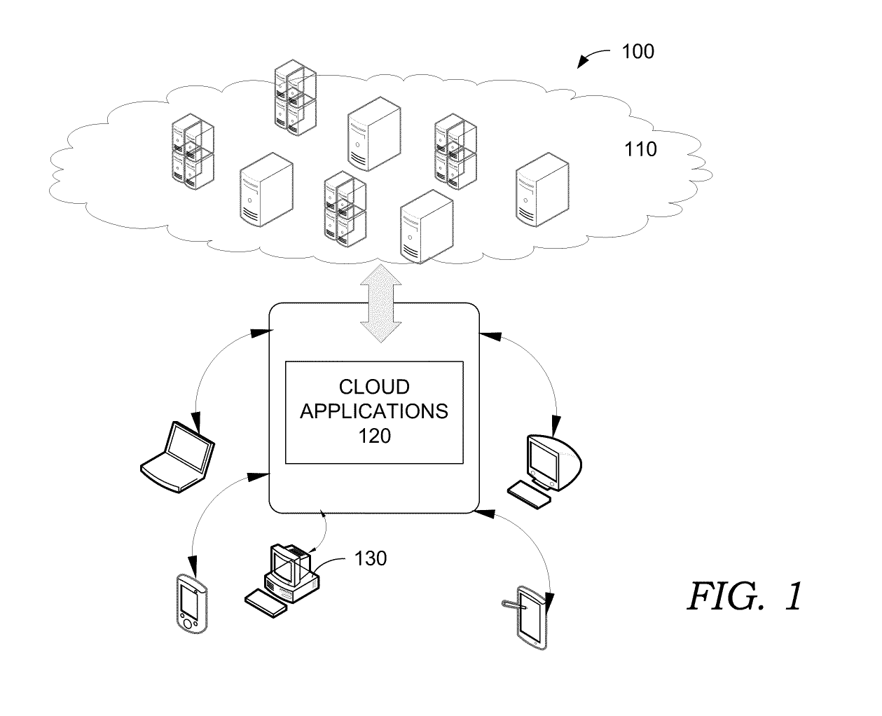

FIG. 1 is a network diagram that illustrates an exemplary cloud computing platform 100 in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a cloud computing platform 110, cloud applications 120, and client devices 130.

The cloud computing platform 110 is configured to execute cloud applications 120 requested by the client devices 130. The cloud computing platform 110 connects to the client devices 130 via a communications network, such as a wireless network, local area network, wired network, or the Internet. The cloud computing platform 110 includes several computing devices that execute the cloud applications. In some embodiments, the computing devices are multiprocessor devices. Each multiprocessor device may include a host virtual machine and guest virtual machines supported by a hypervisor. The host operating system typically manages all of the resources in the multiprocessor devices. When using virtualization technology on the multiprocessor devices, the hypervisors work together with the operating system to manage the resources and to support virtual machines running on the multiprocessor devices.

The cloud applications 120 are available to the client devices 130. The software executed on the cloud computing platform 110 implements the cloud applications 120. In one embodiment, guest virtual machines in the cloud computing platform 110 execute the cloud applications 120. The cloud applications 120 may include editing applications, network management applications, finance applications, or any application requested or developed by the client devices 130.

The cloud computing platform 110 may be instructed to generate a debuggable dump file for a specified guest virtual machine. The debuggable dump file is parsed by a debugger to allow an administrator or developer to diagnose and cure defects in software resources. The debuggable dump file provides a consistent snapshot of the state of a guest virtual machine executing in the cloud computing platform 110. The cloud computing platform 110 suspends all virtual processors in the guest virtual machine when generating the debuggable dump file to prevent an application process from modifying the memory contents during generation of the debuggable dump file. This ensures that the relationship between objects stored in memory is captured correctly as they existed just prior to a request to generate the debuggable dump file.

The client devices 130 are utilized by a user to interact with cloud applications 120 provided by the cloud computing platform 110. The client devices 130, in some embodiments, register with the cloud computing platform 110 to access the cloud applications 120. Any client device 130 with an account from the cloud computing platform 110 may access the cloud applications 120 and other resources provided in the cloud computing platform 110. The client devices 130 include, without limitation, personal digital assistants, smart phones, laptops, personal computers, gaming systems, set-top boxes, or any other suitable client computing device. The client devices 130 may communicate with the cloud computing platform 110 to receive information from, or to access application processes associated with, the cloud applications 120.

Accordingly, the computing system 100 is configured with a cloud computing platform 110 that provides cloud applications 120 to the client devices 130. The cloud applications 120 remove the burden of updating and managing multiple local client applications on the client devices 130.

In certain embodiments, the cloud computing platform provides computing devices that may run virtualization software. A computing device may include a host virtual machine and guest virtual machines supported by a hypervisor. The host virtual machines may execute a host operating system. The guest virtual machines may execute guest operating systems and applications in parallel with the host operating system executed by the host virtual machines. The hypervisor allows the host virtual machines and guest virtual machines to share common resources, e.g. input resources, output resources, etc. All the virtual processors in the guest virtual machines are paused when generating the debuggable dump file.

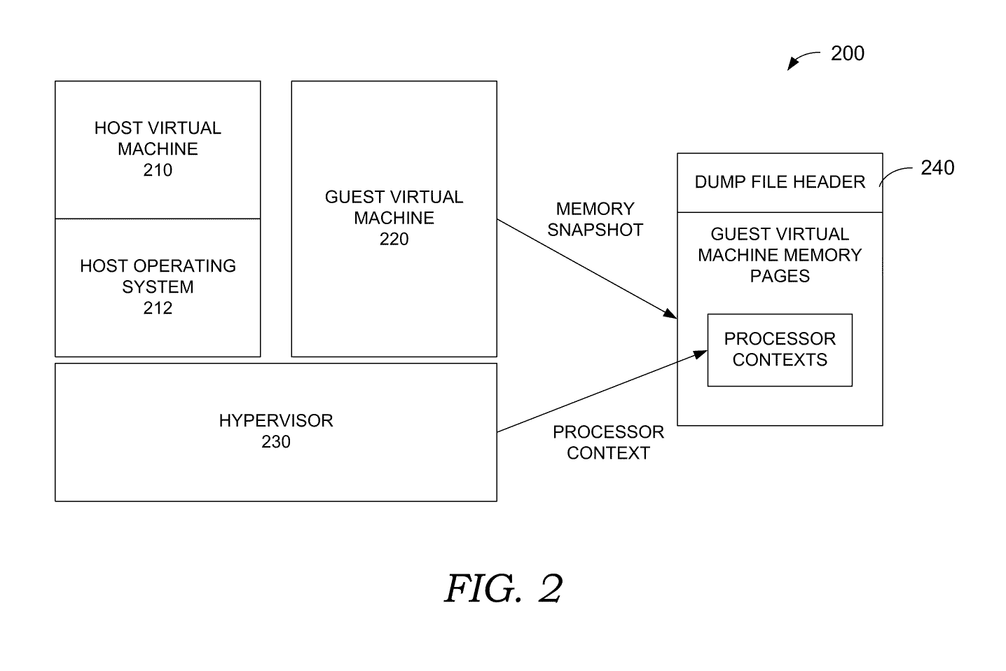

FIG. 2 is a block diagram that illustrates an exemplary computing device configured to generate a debuggable dump file 240 in the exemplary cloud computing platform. The exemplary cloud computing device includes a host virtual machine 210 running a host operating system 212, guest virtual machine 220, and a hypervisor 230.

The hypervisor 230 may be used to virtualize the resources of the computing device. The hypervisor 230 provides several virtual machines executing on a single computing device. A host virtual machine 210 with a host operating system 212 manages the hardware resources on the computing device. In one embodiment, the hypervisor 230 and host operating system 212 work together to manage each of the guest virtual machines 220. Each guest virtual machine 220 may also execute operating systems that differ from the host operating system 212.

The host operating system 212 is executed by the host virtual machine 210 to provide memory management and to allow the computing device to install and execute multiple applications and processes corresponding to the applications. In one embodiment, the host operating system 212 is a Windows™ operating system. The host operating system 212 controls memory management and attempts to reduce resource contention. The host operating system 212 provides numerous data structures and procedures that are available to reduce resource contention among the application processes executed on the host virtual machine 210.

The host operating system 212 is instructed to generate a debuggable dump file for a guest virtual machine 220 executing in the computing device. The host operating system 212 manages access to storage resources, computation resources, and rendering resources of the computing device. The host operating system 212 also receives commands from the administrator of the cloud computing platform.

In response to a generate debuggable dump file command, the host operating system 212 suspends all virtual processors executing on the specified guest virtual machine 220. In one embodiment, the command may be generated by an administrator of the cloud computing platform 110. In turn, memory pages corresponding to the virtual machine are saved to the debuggable dump file 240. In response to the generate debuggable dump file command from the host operating system 212, the hypervisor 230 provides processor context information and debug information for the guest virtual machine 220.

The debuggable dump file 240 is used by a debugger to identify unexpected resource behavior in the computing device. A header for the debuggable dump file 240 may include fields that identify a version for the operating system. The fields comprise any combination of the following: version, size, processor state, references to critical data structures in the virtual machine, and machine type.

The header is followed by entries that describe the memory pages that are saved in the debuggable dump file 240. The debuggable dump file 240 stores the processor contexts and the memory pages of the virtual machine. The debuggable dump file 240 may be loaded into a debugger to diagnose and help fix the unexpected resource behaviors. Accordingly, the debuggable dump file 240 comprises a header and a collection of memory pages that represent a snapshot of the guest virtual machine 220.

In some embodiments, the cloud computing platform ensures that the debuggable dump file is consistent with the memory contents of the virtual machine just prior to receiving the generate debuggable dump file command. In other embodiments, the virtual processors on the guest virtual machine may be resumed prior to writing the memory pages to the debuggable dump file. This allows the guest virtual machine to resume faster and improves availability. In these embodiments, any changes to memory pages of the guest virtual machine are recorded separately and the original contents are preserved. The original contents are subsequently written to the debuggable dump file, thus preserving consistency.

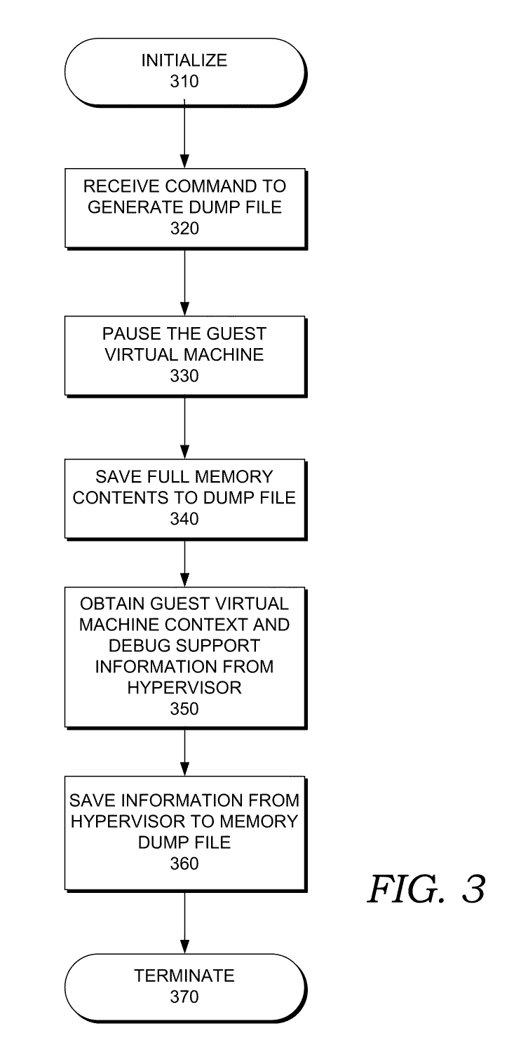

FIG. 3 is a logic diagram that illustrates an exemplary method to generate a debuggable dump file. The method initializes in step 310 when the computing device is powered on. In step 320, the host virtual machine in the computing device receives a command to generate the debuggable dump file. The host virtual machine pauses the guest virtual machine, in step 330. In other words, the virtual processors currently executed by the guest virtual machine are paused in response to the command from the host virtual machine. In step 340, all the memory pages of the virtual machine are written to the debuggable dump file. In some embodiments, the memory pages may selectively include any combination of the following: process state, memory stacks, memory heaps, nonpaged data, and paged data.

In turn, the guest virtual machine context, which includes processor context information, and debug support information are received from the hypervisor in step 350. The guest virtual machine context and debug support information are stored in the debuggable dump file, in step 360. The suspended virtual processors resume after the memory pages are written to the debuggable dump file. Alternatively, the suspended processors resume immediately and changes to the memory pages are recorded separately while preserving the original contents. The debuggable dump file only stores the original contents of the memory pages if any changes occur to the memory pages prior to writing the memory pages from the local cache to the debuggable dump file. The method terminates in step 370.

In some embodiments, a user of a cloud application executing in the cloud computing platform requests a debuggable dump file. The debuggable dump file is generated by processing and merging of information from various sources. The availability of the services in the guest virtual machine is minimally impacted because the guest virtual machine is suspended for a short period of time. The host operating system receives a generate debuggable dump file command. The guest virtual machine is paused for the duration of the operation to obtain a snapshot of the memory pages used by the guest virtual machine. The relevant memory pages of the guest virtual machine are saved to the dump file. The processor context information for the guest virtual machine is obtained from the hypervisor and added to the debuggable dump file. The fields in the debuggable dump file header are filled by gathering the required information from the guest virtual machine memory pages. In turn, the guest virtual machine resumes.

The foregoing descriptions of the embodiments of the invention are illustrative, and modifications in configuration and implementation are within the scope of the current description. For instance, while the embodiments of the invention are generally described with relation to FIGS. 1-3, those descriptions are exemplary. Although the subject matter has been described in language specific to structural features or methodological acts, it is understood that the subject matter defined in the appended claims is not necessarily limited to the specific features or acts described above. Rather, the specific features and acts described above are disclosed as example forms of implementing the claims. The scope of the embodiment of the invention is accordingly intended to be limited only by the following claims.

We claim:

1. A computer-implemented method to generate a debuggable dump file for a virtual machine executing in a computing device, the method comprising:
receiving a request to generate a debuggable dump file for a virtual machine;
suspending all virtual processors executing on the virtual machine; and
storing memory pages associated with the virtual machine in the debuggable dump file;
obtaining virtual machine context information and debug support information from a hypervisor executing in the computing device; and
storing the virtual machine context information and debug support information in the debuggable dump file.

2. The computer-implemented method of claim 1, wherein the debuggable dump file includes a header having several fields.

3. The computer-implemented method of claim 2, wherein the fields comprise any combination of the following: version, size, processor state, references to critical data structures in the virtual machine, and machine type.

4. The computer-implemented method of claim 2, wherein the memory pages saved for the suspended virtual machine include any combination of the following: process state, memory stacks, memory heaps, nonpaged data, and paged data.

5. The computer-implemented method of claim 1, wherein the suspended virtual processors resume after the memory pages are written to the debuggable dump file.

6. The computer-implemented method of claim 1, wherein the suspended virtual processors resume immediately and changes to the pages are recorded separately and original contents are preserved for inclusion in the debuggable dump file which is written later.

7. One or more computer readable media storing instructions to perform a method to create a debuggable dump file of a virtual machine in a cloud computing environment, the method comprising:
receiving a request to generate a debuggable dump file for a virtual machine;
suspend all virtual processors executing on the virtual machine; and
storing memory pages associated with the virtual machine in the debuggable dump file.

8. The computer-readable media of claim 7, further comprising: obtaining virtual machine context information and debug support information from a hypervisor executing in the cloud computing platform.

9. The computer-readable media of claim 8, further comprising: storing the virtual machine context information and debug support information in the debuggable dump file.

10. The computer-readable media of claim 7, wherein the memory pages saved for the suspended virtual machine include any combination of the following: processor state, memory stacks, memory heaps, nonpaged data, and paged data.

11. The computer-readable media of claim 7, wherein the debuggable dump file includes a header having several fields.

12. The computer-readable media of claim 11, wherein the fields comprise any combination of the following: version, size, processor state, references to critical data structures, and machine type.

13. The computer-readable media of claim 7, wherein the suspended virtual processors resume after the memory pages are written to the debuggable dump file.

14. The computer-readable media of claim 7, wherein the suspended virtual machines resume immediately and changes to the pages are recorded separately and original contents are preserved for inclusion in the debuggable dump file which is written later.

15. A cloud computing platform configured to generate a debuggable dump file, the cloud computing platform comprising:
a server having a host virtual machine, a guest virtual machine, and a hypervisor, wherein the host virtual machine executes a host operating system and the guest virtual machine executes a guest operating system and applications; and
the host virtual machine is configured to receive a request to generate a debuggable dump file and in response to the request, the server suspends the guest virtual machine, and stores memory pages of the virtual machine in the debuggable dump file.

16. The cloud computing platform of claim 15, wherein the debuggable dump file stores virtual machine context information and debug support information obtained from the hypervisor.

17. The cloud computing platform of claim 16, wherein the memory pages include any combination of the following: processor state, memory stacks, nonpaged data, and paged data.

18. The cloud computing platform of claim 17, wherein the guest virtual machine resumes after the memory pages are written to the debuggable dump file.

19. The cloud computing platform of claim 17, wherein the guest virtual machine resumes immediately.

20. The cloud computing platform of claim 19, wherein changes to the pages are recorded separately and original contents are preserved for inclusion in the debuggable dump file which is written later.
